(19) United States
(12) Patent Application Publication
(10) Pub. No.: US 2019/0353229 A1
(43) Pub. Date: Nov. 21, 2019

(54) BALL TYPE SPEED REDUCER

(71) Applicant: ENPLAS CORPORATION, Saitama (JP)

(72) Inventor: Yasushi KAJIWARA, Saitama (JP)

(21) Appl. No.: 16/461,643

(22) PCT Filed: Oct. 31, 2017
(86) PCT No.: PCT/JP2017/039304

§ 371 Date: May 16, 2019

(30) Foreign Application Priority Data
Nov. 17, 2016 (JP) 2016-224235

(51) Int. Cl. F16H 25/06; F16H 1/32; F16H 13/08

(52) U.S. Cl. CPC F16H 25/06; F16H 2025/063; F16H 13/08; F16H 1/32

(57) ABSTRACT

A ball type speed reducer includes: an eccentric disk cam rotating in synchronization with an input-side rotating body; a shaking body fitted relatively rotatably to an outer circumference side of the eccentric disk cam to be shaken; balls rollably housed in a ball holding portion of the shaking body; and a fixing member having a first side face portion facing one side face of the shaking body. Radial grooves for radially guiding the balls are formed in the first side face portion. An output-side rotating body has a second side face portion facing the other side face of the shaking body. An annular corrugated groove for guiding the balls circumferentially in an undulating manner is formed in the second side face portion. The balls are engaged with the radial grooves and the corrugated groove and are rolled inside the radial grooves and the corrugated groove as the shaking body is shaken.

### TECHNICAL FIELD

The present invention relates to a ball type speed reducer used for decelerating and transmitting rotation.

### BACKGROUND ART

In the prior art, a ball type speed reducer is used in a power transmission unit of various types of machines (such as an industrial robot or a steering angle variable type steering system) because it is small-sized and can obtain a larger reduction ratio, compared to a mechanical reduction gear.

FIG. 14 is a diagram illustrating the ball type speed reducer 100 of the prior art. Note that FIG. 14A is a longitudinal cross-sectional view illustrating the ball type speed reducer 100 of the prior art, and FIG. 14B is a cross-sectional view taken along the line A13-A13 of FIG. 14A to illustrate the ball type speed reducer 100.

As illustrated in FIG. 14, the ball type speed reducer 100 has an eccentric rotating plate 104 installed in an outer circumference side of an eccentric cam 102 provided in an input shaft 101 by interposing a bearing 103, so that the eccentric rotating plate 104 is eccentrically driven by the eccentric cam 102. In addition, in this ball type speed reducer 100, an output-side rotating body 105 coupled to an output shaft (not shown) is disposed in both inner sides of a radial direction of the eccentric rotating plate 104, and the input shaft 101 is relatively rotatably supported by an inner circumference side of the output-side rotating body 105 by interposing a bearing 106. In addition, in this ball type speed reducer 100, a fixing member 107 fixed to a part of an industrial robot or the like is disposed in both outer sides of the radial direction of the eccentric rotating plate 104 by interposing balls 108, and the output-side rotating body 105 is rotatably supported by the inner circumference side of the fixing member 107 by interposing a bearing 110. In addition, the balls 108 interposed between the eccentric rotating plate 104 and the fixing member 107 are rollably engaged with a first corrugated groove (first cycloid groove formed in an epicycloid curve) 111 formed on a side face of the eccentric rotating plate 104 and a second corrugated groove (second cycloid groove formed in a hypocycloid curve) 112 formed on the inner side face (side face facing the eccentric rotating plate 104) of the fixing member 107 to connect the eccentric rotating plate 104 and the fixing member 107. Note that the number of waves of the second corrugated groove 112 is larger than the number of waves of the first corrugated groove 111 by two waves.

The output-side rotating body 105 is connected to the eccentric rotating plate 104 by interposing an eccentricity absorption mechanism 113. The eccentricity absorption mechanism 113 allows the eccentric rotating plate 104 to make an eccentric motion against the output-side rotating body 105 (to absorb eccentricity of the eccentric rotating plate 104) and transmits rotation of the eccentric rotating plate 104 to the output-side rotating body 105. The eccentricity absorption mechanism 113 has a plurality of balls 114 interposed between the eccentric rotating plate 104 and the output-side rotating body 105, a driving annular groove 115 of the eccentric rotating plate 104 that rollably houses the balls 114, and a follower annular groove 116 of the output-side rotating body 105. The driving annular groove 115 and the follower annular groove 116 have shapes and sizes determined by considering the eccentric amount of the eccentric cam 102, and the eccentric rotating plate 104 allows a movement of the ball 114 for making eccentric rotation with respect to a rotation center of the input shaft 101 to rotate the output-side rotating body 105 in synchronization with the eccentric rotating plate 104 by interposing the balls 114 (see Patent Document 1).

In such a ball type speed reducer 100 of the prior art, for example, when the number of waves of the first corrugated groove 111 of the eccentric rotating plate 104 is set to “N−2”, and the number of waves of the second corrugated groove 112 of the fixing member 107 is set to “N”, as the input shaft 101 is rotationally driven by a motor (not shown) or the like, the eccentric rotating plate 104 is eccentrically driven by the eccentric cam 102 of the input shaft 101, and the output-side rotating body 105 rotates in synchronization with the eccentric rotating plate 104 by interposing the eccentricity absorption mechanism 113. However, the output-side rotating body 105 rotates by “−2/(N−2)” for one rotation of the input shaft 101 (rotation by “2/(N−2)” oppositely to the rotational direction of the input shaft 101). That is, the ball type speed reducer 100 of the prior art has a reduction ratio of “2/(N−2)” when the number of waves of the first corrugated groove 111 of the eccentric rotating plate 104 is set to “N−2”, and the number of waves of the second corrugated groove 112 of the fixing member 107 is set to “N”.

### [CITATION LIST]

### [Patent Documents]

Patent Document 1: Japanese Unexamined Patent Application Publication No. 5-10400

### SUMMARY OF INVENTION

However, in the ball type speed reducer 100 of the prior art illustrated in FIG. 14, the first corrugated groove 111 is formed in both side faces of the eccentric rotating plate 104, and the second corrugated groove 112 is formed on the inner side face of the fixing member 107 disposed in both sides of the eccentric rotating plate 104. Therefore, it is necessary to form the corrugated grooves 111 and 112 in a total of four side faces (four portions) with high accuracy, and this increases man-hours disadvantageously.

In the ball type speed reducer 100 of the prior art illustrated in FIG. 14, in order to rotate the eccentric rotating plate 104 and the output-side rotating body 105 in synchronization, the output-side rotating body 105 is connected to the eccentric rotating plate 104 by interposing the eccentricity absorption mechanism 113. Therefore, it has a complicated structure, and increases man-hours disadvantageously.

In view of the aforementioned problems, it is therefore an object of the present invention to provide a ball type speed reducer having a simple structure and reduced man-hours.

The present invention relates to a ball type speed reducer 1 that decelerates and transmits rotation of an input-side rotating body 2 to an output-side rotating body 7. The ball type speed reducer 1 of the present invention includes: an eccentric disk cam 3 rotating in synchronization with the input-side rotating body 2; a shaking body 4 (or 55) fitted relatively rotatably to an outer circumference side of the eccentric disk cam 3 and shaken by the eccentric disk cam 3; a plurality of balls 5 housed in a ball holding portion 23 (or 56) of the shaking body 4 (or 55); and a fixing member 6 having a first side face portion 24 placed to face one of both side faces 4a and 4b (or 55a and 55b) of the shaking body 4 (or 55) and fixed to a fixation target member. In addition, the ball holding portion 23 (or 56) of the shaking body 4 (or 55) is formed along a relative rotation direction between the shaking body 4 (or 55) and the eccentric disk cam 3 to rollably house the plurality of balls 5 along the relative rotation direction. In addition, the output-side rotating body 7 has a second side face portion 40 positioned to face the other of both side faces 4a and 4b (or 55a and 55b) of the shaking body 4 (or 55) and has a shaft center 42a as a rotation center positioned coaxially with the rotation center 2a of the input-side rotating body 2. In addition, when a direction extending radially from the rotation center 2a is set as a radial direction on a virtual plane perpendicular to the rotation center 2a of the input-side rotating body 2, any one of the first and second side face portions 24 and 40 has a plurality of radial grooves 30 formed around the rotation center 2a of the input shaft side rotating body 2 to rollably guide the balls 5 along the radial direction of any one of the first and second side face portions 24 and 40. In addition, when a direction extending along an outer edge of a virtual circle centered at the rotation center 2a on the virtual plane is set as a circumferential direction, the other one of the first and second side face portions 24 and 40 has an annular corrugated groove 31 (or 61, 62) formed to guide the balls 5 along the circumferential direction of the other one of the first and second side face portions 24 and 40 in an undulating manner. In addition, the balls 5 are rollably engaged inside the radial grooves 30 and the corrugated groove 31 (or 61, 62) and are rolled inside the radial grooves 30 and the corrugated groove 31 (or 61, 62) as the shaking body 4 (or 55) is shaken by the eccentric disk cam 3.

The ball type speed reducer according to the present invention has the corrugated groove formed on only one of the side face portions of the output-side rotating body and the fixing member facing the shaking body. Therefore, it is possible to reduce the man-hours, compared to the prior art in which the corrugated groove is formed in each of four side faces. In addition, the ball type speed reducer according to the present invention has the shaking body that can be shaken independently from the output-side rotating body and the fixing member. Therefore, it is not necessary to provide a complicated mechanism for rotating the output-side rotating body and the shaking body in synchronization. Accordingly, it is possible to simplify the structure and reduce the man-hours.

### BRIEF DESCRIPTION OF DRAWINGS

FIG. 1 is a longitudinal cross-sectional view illustrating a ball type speed reducer according to a first embodiment of the invention;

FIG. 2 is a diagram illustrating an input shaft (input-side rotating body) of a ball type speed reducer according to a first embodiment of the invention, in which FIG. 2A is a front view illustrating an input shaft as seen from the arrow direction B1 of FIG. 2C, FIG. 2B is a cross-sectional view taken along the line A1-A1 of FIG. 2C, and FIG. 2C is a side view illustrating the input shaft;

FIG. 3 is a diagram illustrating a shaking body of the ball type speed reducer according to the first embodiment of the invention, in which FIG. 3A is a longitudinal cross-sectional view illustrating the shaking body (cross-sectional view taken along the line A2-A2 of FIG. 3B), FIG. 3B is a front view illustrating the shaking body, FIG. 3C is a longitudinal cross-sectional view illustrating an inner shake ring (cross-sectional view taken along the line A3-A3 of FIG. 3D, FIG. 3D is a front view illustrating the inner shake ring, and FIG. 3E is a longitudinal cross-sectional view illustrating an outer shake ring (cross-sectional view taken along the line A4-A4 of FIG. 3F);

FIG. 4 is a diagram illustrating a fixing member of the ball type speed reducer according to the first embodiment of the invention, in which FIG. 4A is a front view illustrating the fixing member, and FIG. 4B is a longitudinal cross-sectional view illustrating the fixing member (cross-sectional view taken along the line A5-A5 of FIG. 4A to illustrate the fixing member);

FIG. 5 is a diagram illustrating an output-side rotating body of the ball type speed reducer according to the first embodiment of the invention, in which FIG. 5A is a diagram illustrating a leading end face of an output shaft portion (illustrating the output shaft portion as seen from the arrow direction B2 of FIG. 5B), FIG. 5B is a longitudinal cross-sectional view illustrating the output-side rotating body (cross-sectional view taken along the line A6-A6 of FIG. 5C), and FIG. 5C is a front view illustrating the output-side rotating body (illustrating the output-side rotating body as seen from the arrow direction B3 of FIG. 5B);

FIG. 6 is a diagram illustrating a cover of the ball type speed reducer according to the first embodiment of the invention, in which FIG. 6A is a front view illustrating the cover, and FIG. 6B is a cross-sectional view taken along the line A7-A7 of FIG. 6A to illustrate the cover;

FIG. 7 is a diagram illustrating a modification of the fixing member of the ball type speed reducer according to the first embodiment of the invention, in which FIG. 7A is a front view illustrating the fixing member, and FIG. 7B is a longitudinal cross-sectional view illustrating the fixing member (cross-sectional view taken along the line A8-A8 of FIG. 7A to illustrate the fixing member);

FIG. 8 is a diagram illustrating a modification of the shaking body of the ball type speed reducer according to the first embodiment of the invention, in which FIG. 8A is a longitudinal cross-sectional view illustrating the shaking body (cross-sectional view taken along the line A9-A9 of FIG. 8B to illustrate the shaking body), and FIG. 8B is a front view illustrating the shaking body, and FIG. 8C is an enlarged view illustrating a ball holding portion of the shaking body;

FIG. 9 is a diagram illustrating a modification of a corrugated groove formed on the output-side rotating body of the ball type speed reducer according to the first embodiment of the invention;

FIG. 10 is a longitudinal cross-sectional view illustrating a ball type speed reducer according to a second embodiment of the invention;

FIG. 11 is a diagram illustrating a fixing member of the ball type speed reducer according to the second embodiment of the invention, in which FIG. 11A is a front view illustrating the fixing member, and FIG. 11B is a longitudinal cross-sectional view illustrating the fixing member (cross-sectional view taken along the line A10-A10 of FIG. 11A to illustrate the fixing member);

FIG. 12 is a diagram illustrating an output-side rotating body of the ball type speed reducer according to the second embodiment of the invention, in which FIG. 12A is a diagram illustrating a leading end face of an output shaft portion (illustrating the output shaft portion as seen from the arrow direction B4 of FIG. 12B), FIG. 12B is a longitudinal cross-sectional view illustrating the output-side rotating body (cross-sectional view taken along the line A11-A11 of FIG. 12C), and FIG. 12C is a front view illustrating the output-side rotating body (as seen from the arrow direction B5 of FIG. 12B);

FIG. 13 is a diagram illustrating a modification of the output-side rotating body of the ball type speed reducer according to the second embodiment of the invention, in which FIG. 13A is a longitudinal cross-sectional view illustrating the output-side rotating body (cross-sectional view taken along the line A12-A12 of FIG. 13B to illustrate the output-side rotating body), and FIG. 13B is a front view illustrating the output-side rotating body (diagram illustrating the output-side rotating body as seen from the arrow direction B6 of FIG. 13A); and

FIG. 14 is a diagram illustrating a ball type speed reducer of the prior art, in which FIG. 14A is a longitudinal cross-sectional view illustrating the ball type speed reducer, and FIG. 14B is a cross-sectional view taken along the line A13-A13 of FIG. 14A.

### DESCRIPTION OF EMBODIMENTS

Embodiments of the present invention will now be described with reference to the accompanying drawings.

### First Embodiment

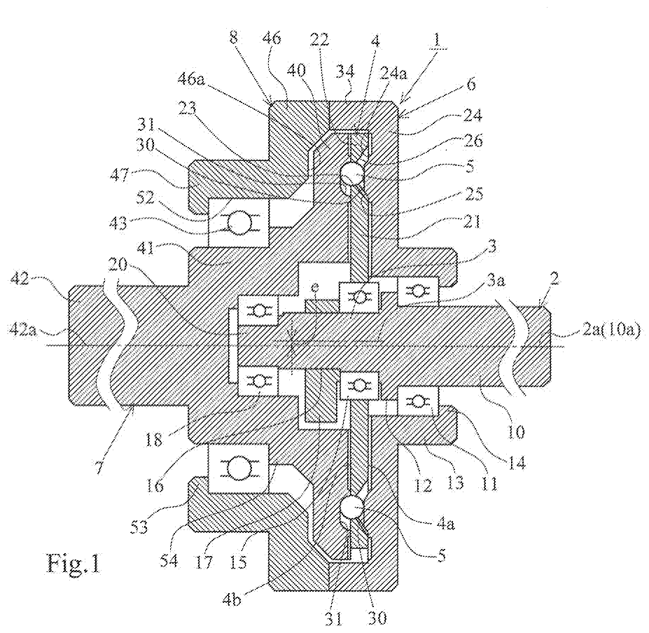

FIG. 1 is a longitudinal cross-sectional view illustrating a ball type speed reducer 1 according to a first embodiment of the invention. As illustrated in FIG. 1, the ball type speed reducer 1 according to this embodiment includes an input shaft (input-side rotating body) 2, an eccentric disk cam 3, a shaking body 4, a plurality of balls (steel balls) 5, a fixing member 6, an output-side rotating body 7, a cover 8, and the like.

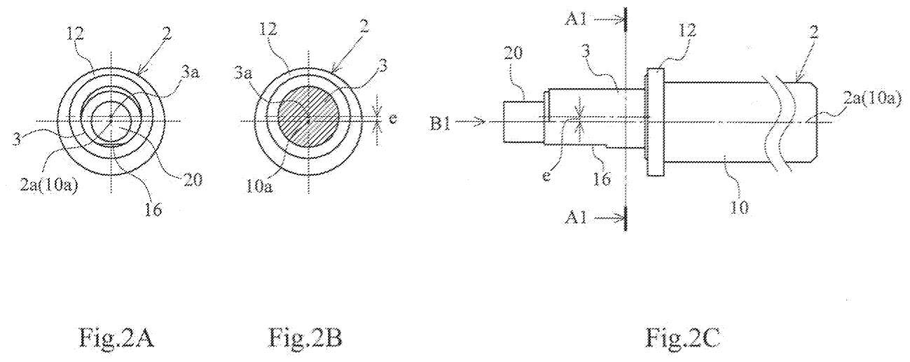

As illustrated in FIGS. 1 and 2, a shaft body portion 10 of the input shaft 2 is rotatably supported by the fixing member 6 by interposing a first bearing 11, so that the input shaft 2 is rotationally driven by a motor or the like (not shown). In this input shaft 2, a flange-like portion 12 having a diameter larger than that of the shaft body portion 10 is formed adjacent to the shaft body portion 10, and a side face of the first bearing 11 abuts on the side face of the flange-like portion 12, so that the first bearing 11 is held between an inner protrusion 14 of a boss portion 13 of the fixing member 6 and the flange-like portion 12. In addition, the input shaft 2 has an eccentric disk cam 3 formed closer to a shaft tip side than the flange-like portion 12 and in the vicinity of the flange-like portion 12. This eccentric disk cam 3 is a disk having a center 3a decentered from a rotation center 2a of the input shaft 2 (a rotation center 10a of the shaft body portion 10) by an eccentric amount (e), and is eccentrically rotated in synchronization with the input shaft 2 by virtue of rotation of the rotation center 2a of the input shaft 2. In addition, the shaking body 4 is relatively rotatably installed in the outer circumference side of the eccentric disk cam 3 by interposing a second bearing 15. Furthermore, the input shaft 2 has a balance weight installation portion 16 formed in the outer periphery of the eccentric disk cam 3 and closer to the shaft tip side than a portion where the second bearing 15 is installed. The balance weight installation portion 16 is a part formed such that one portion of the outer circumference side of the eccentric disk cam 3 is notched along the line indicating the center 3a of the eccentric disk cam 3 (D-cut portion illustrated in FIG. 2A). In addition, a balance weight 17 is pressedly inserted and fixed to the balance weight installation portion 16, and the second bearing 15 is held between the balance weight 17 and the flange-like portion 12 in the positioned state. Furthermore, the input shaft 2 has a tip shaft portion 20 formed to install a third bearing 18. This tip shaft portion 20 has a rotation center concentric with the rotation center 2a of the shaft body portion 2 and rotatably supports the output-side rotating body 7 by interposing the third bearing 18. Note that, in the following description, considering a virtual plane perpendicular to the rotation center 2a of the input shaft 2, it is assumed that a radial direction refers to a direction extending radially from the rotation center 2a on a virtual plane. Furthermore, considering the virtual plane perpendicular to the rotation center 2a of the input shaft 2, it is assumed that a circumferential direction refers to a direction along an outer edge of a virtual circle centered at the rotation center 2a of the input shaft 2.

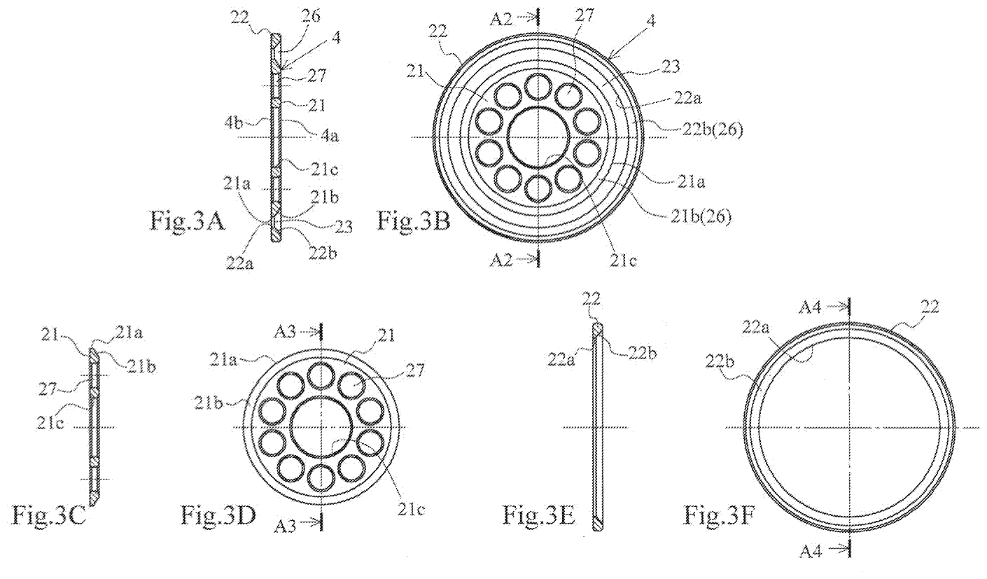

As illustrated in FIGS. 1 and 3, the shaking body 4 is shaken by the eccentric disk cam 3 and has an inner shake ring 21 and an outer shake ring 22. In addition, the shaking body 4 has a ball holding portion 23 formed between the inner shake ring 21 and the outer shake ring 22, so that a plurality of balls 5 are rollably housed in the ball holding portion 23. The ball holding portion 23 of the shaking body 4 is an annular space formed between an outer circumferential surface 21a of the inner shake ring 21 and an inner circumferential surface 22a of the outer shake ring 22 (space formed along the relative rotation direction between the shaking body 4 and the eccentric disk cam 3), and the outer shake ring 22 is rollably supported by a plurality of balls 5 arranged circumferentially on the outer circumferential surface 21a of the inner shake ring 21. Furthermore, the shaking body 4 has a ball support protrusion relief portion 26 formed to house the ball support protrusion 25 formed in the first side face portion 24 of the fixing member 6 described below and allow relative rotation with respect to the fixing member 6. The ball support protrusion relief portion 26 includes an inner tapered surface 21b formed to slantingly notch the outer circumferential surface 21a of the inner shake ring 21 inward of the radial direction, and an outer tapered surface 22b formed to slantingly notch the inner circumferential surface 22a of the outer shake ring 22 outward of the radial direction, and has a cross-section shape enlarged toward the first side face portion 24 of the fixing member 6. In addition, the first side face portion 24 of the fixing member 6 is disposed in one side face 4a of both side faces 4a and 4b of the shaking body 4 to face each other. Note that the inner shake ring 21 has a plurality of lightening holes 27 formed circumferentially at equal intervals between the bearing surface 21c fitted to the second bearing 15 and the outer circumferential surface 21a that supports the balls 5.

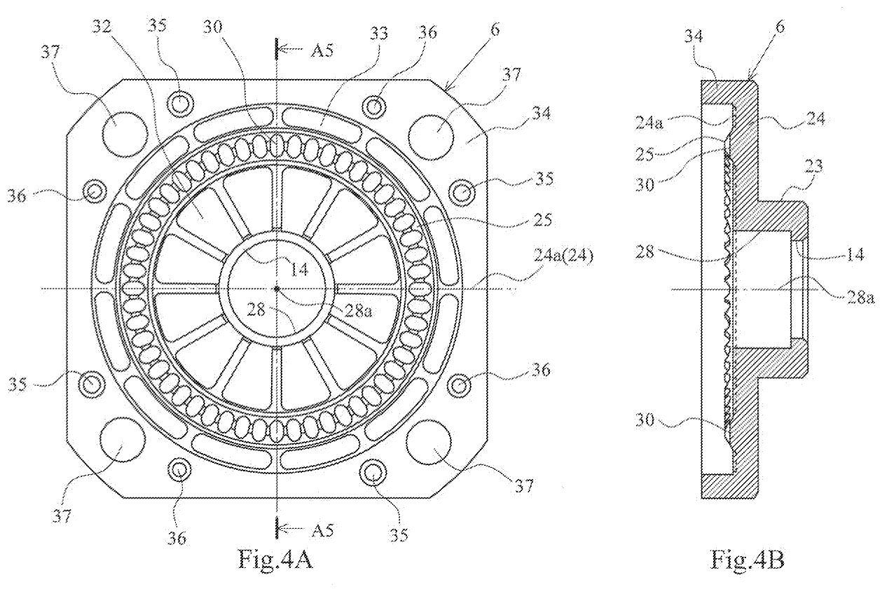

As illustrated in FIGS. 1 and 4, the fixing member 6 is fixed to a fixation target member (not shown) (such as a machine frame or a robot arm) to allow the first bearing 11 installed on the inner circumferential surface of the boss portion 13 to rotatably support the shaft body portion 10 of the input shaft 2. In addition, the fixing member 6 has a ball support protrusion 25 formed on an inner face 24a of the first side face portion 24 facing the one of the side faces 4a of the shaking body 4 (the side face facing the one of the side faces 4a) and engaged with the ball support protrusion relief portion 26 of the shaking body 4 in a non-contact manner. The ball support protrusion 25 is an annular body that has a tapered trapezoidal cross-sectional shape and is concentric with a center 28a of a bearing installation hole 28 of the boss portion 13. In addition, the ball support protrusion 25 has a plurality of radial grooves 30 formed circumferentially at equal intervals and engaged with the balls 5 housed in the ball holding portion 23 of the shaking body 4. The radial grooves 30 are formed to notch the ball support protrusion 25 in the radial direction, and a cross-sectional shape perpendicular to the radial direction is an arc shape having a radius of curvature matching the radius of the ball 5, so that the same groove depth is provided from the radial inner end to the radial outer end. Furthermore, when the number of waves of the corrugated groove 31 of the output-side rotating body 7 is set to “N”, the radial grooves 30 of the fixing member 6 are formed in (N+1) portions, so as to rollably house the (N+1) balls 5 one by one. Such radial grooves 30 of the fixing member 6 can roll the balls 5 in the radial direction depending on a shake amount of the shake body 4 as the eccentric disk cam 3 rotates by one turn, and the shaking body 4 is shaken by one stroke. In addition, the fixing member 6 has a plurality of contact relief recesses 32 and 33 circumferentially formed in the first side face portion 24 radially inward of the ball support protrusion 25 and the first side face portion 24 radially outward of the ball support protrusion 25, in order to reduce a contact resistance by reducing a contact area between the first side face portion 24 and the shaking body 4. Furthermore, the fixing member 6 has a cover installation portion 34 formed in the radial outer end side. Moreover, the shaking body 4 is shakably housed in the inner side of the cover installation portion 34, and the output-side rotating body 7 is rotatably housed. In addition, the cover installation portion 34 of the fixing member 6 has a rectangular exterior shape as seen from the front side, and each corner portion (four corners) has a positioning pin installation hole 35, an assembly thread hole 36, and a fixation bolt insertion hole 37. A positioning pin (not shown) engaged with the positioning pin engagement hole 48 of the cover 8 is pressedly inserted into the positioning pin installation hole 35. As a result, the cover 8 is fixed while being positioned in the fixing member 6. In addition, a thread portion (not shown) of the assembly bolt for fixing the cover 8 to the fixing member 6 is screwed to the assembly thread hole 36. Furthermore, a shank portion (not shown) of the fixation bolt for integrally installing the cover 8 and the fixing member 6 in a fixation target member (not shown) is inserted into the fixation bolt insertion hole 37. Note that a lubricant such as grease is appropriately applied to the contact relief recesses 32 and 33 of the fixing member 6.

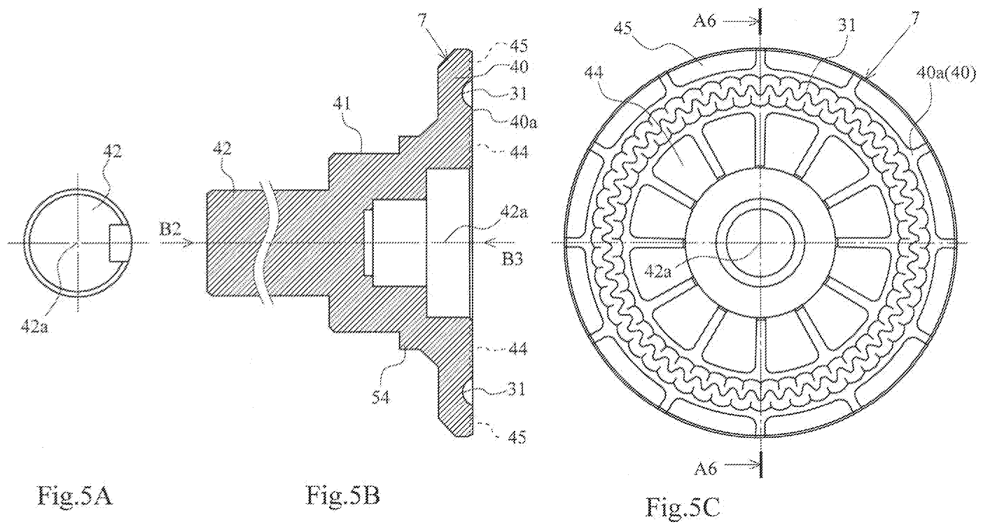

As illustrated in FIGS. 1 and 5, the output-side rotating body 7 includes a second side face portion 40 positioned to face the other side face 4b of both side faces 4a and 4b of the shaking body 4, a bearing cylinder portion 41 formed integrally inward of the second side face portion 40 in the radial direction, and an output shaft portion 42 formed integrally with the bearing cylinder portion 41. In the output-side rotating body 7, the inner circumference side of the bearing cylinder portion 41 is rotatably supported by the tip shaft portion 20 of the input shaft 2 by interposing a third bearing 18, and the outer circumference side of the bearing cylinder portion 41 is rotatably supported by the cover 8 by interposing a fourth bearing 43, so that the output shaft portion 42 rotates concentrically with the rotation center 2a of the input shaft 2. In addition, on the inner face 40a of the second side face portion 40 (side face facing the other side face 4b of the shaking body 4), a corrugated groove 31 engaged with the balls 5 housed in the ball holding portion 23 of the shaking body 4 is formed in an annular shape (in an endless shape) around the rotation center (shaft center) 42a of the output shaft portion 42. The corrugated groove 31 guides the balls 5 in a circumferential direction of the second side face portion 40 in an undulating manner. In addition, the output-side rotating body 7 rotates by one wave of the corrugated groove 31 as the eccentric disk cam 3 rotates by one turn, the shaking body 4 shakes by one stroke, and the ball 5 reciprocates inside the radial groove 30 of the fixing member 6 by one trip in the radial direction. The output shaft portion 42 has a rotation center 42a placed concentrically with the rotation center of the input shaft 2 and is coupled to a driven member (not shown). In addition, in order to reduce a contact resistance by reducing a contact area between the second side face portion 40 and the shaking body 4, the output-side rotating body 7 has a plurality of contact relief recesses 44 formed circumferentially in the second side face portion 40 inward of the corrugated groove 31 in the radial direction and a plurality of contact relief recesses 45 formed circumferentially in the second side face portion 40 outward of the corrugated groove 31 in the radial direction. Note that a lubricant such as grease is appropriately applied to the contact relief recesses 44 and 45.

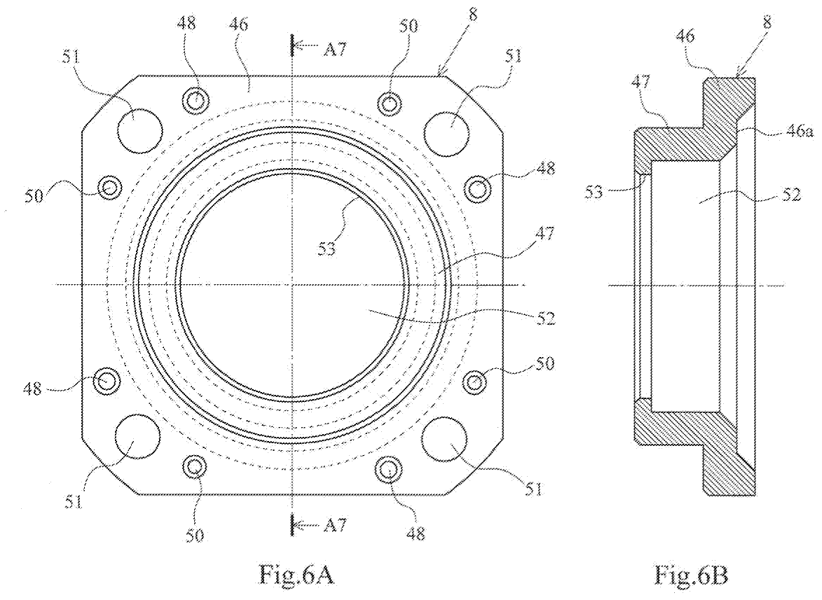

As illustrated in FIGS. 1 and 6, the cover 8 has a flange portion 46 and a cylindrical portion 47 formed integrally, and has a space for rotatably housing the output-side rotating body 7 inward in the radial direction. The flange portion 46 has a substantially rectangular exterior shape as seen from the front side, which is similar to that of the cover installation portion 34 of the fixing member 6, and a positioning pin engagement hole 48, an assembly bolt installation hole 50, and a fixation bolt insertion hole 51 are provided in each corner portion (four corners). The positioning pin engagement hole 48, the assembly bolt installation hole 50, and the fixation bolt insertion hole 51 of the cover 8 are provided to match the positioning pin installation hole 35, the assembly thread hole 36, and the fixation bolt insertion hole 37 of the fixing member 6 one by one. In addition, a positioning pin (not shown) fixed to the fixing member 6 is inserted into the positioning pin engagement hole 48. Furthermore, an installation bolt (not shown) for fixing the fixing member 6 and the cover 8 by fastening is engaged with the assembly bolt installation hole 50. Moreover, a fixation bolt (not shown) for integrally installing the cover 8 and the fixing member 6 in an installation target object (not shown) is engaged with the fixation bolt insertion hole 51. The flange portion 46 of the cover 8 is disposed such that a gap is provided between the side face 46a facing the output-side rotating body 7 and second side face portion 40 of the output-side rotating body 7. In addition, the cylindrical portion 47 of the cover 8 rotatably supports the bearing cylinder portion 41 of the output-side rotating body 7 by interposing the fourth bearing 43 such that the inner circumferential surface of the bearing fitting hole 52 is fitted to the outer circumferential surface of the fourth bearing 43. Furthermore, a bearing positioning protrusion 53 positioned in the side face side of the outer race of the fourth bearing 43 is provided in an axial end of the cylindrical portion 47. The fourth bearing 43 is housed between the bearing positioning protrusion 53 and the bearing positioning step portion 54 of the output-side rotating body 7, so that the fourth bearing 43 is prevented from being removed from a gap between the output-side rotating body 7 and the cover 8.

In the ball type speed reducer 1 according to this embodiment described above, as the input shaft 2 and the eccentric disk cam 3 rotate in synchronization by one turn, the shaking body 4 is shaken by a dimension (2e) twice the eccentric amount (e) of the eccentric disk cam 3, so that the balls 5 housed in the ball holding portion 23 of the shaking body 4 reciprocate inside the radial grooves 30 of the fixing member 6 by one trip. In this case, the output-side rotating body 7 rotates with respect to the fixing member 6 by one wave of the corrugated groove 31 because the balls 5 move in the radial direction of the first side face portion 24 inside the radial groove 30 of the fixing member 6. Therefore, in the ball type speed reducer 1 according to this embodiment, since the number of waves of the corrugated groove 31 is set to “N”, and the number of grooves of the radial groove 30 is set to “N+1”, the output-side rotating body 7 rotates by a “1/N” turn oppositely to the input shaft 2 while the input shaft 2 rotates by one turn. Note that, as illustrated in FIGS. 4 and 5, in the ball type speed reducer 1 according to this embodiment, the number “N” of waves of the corrugated groove 31 of the output-side rotating body 7 is set to “51”, and the number “N+1” of grooves of the radial groove 30 of the fixing member 6 is set to “52” by way of example. Therefore, the ball type speed reducer 1 according to this embodiment decelerates rotation of the input shaft 2 by “1/51 (1/N)” and transmits the decelerated rotation to the output-side rotating body 7.

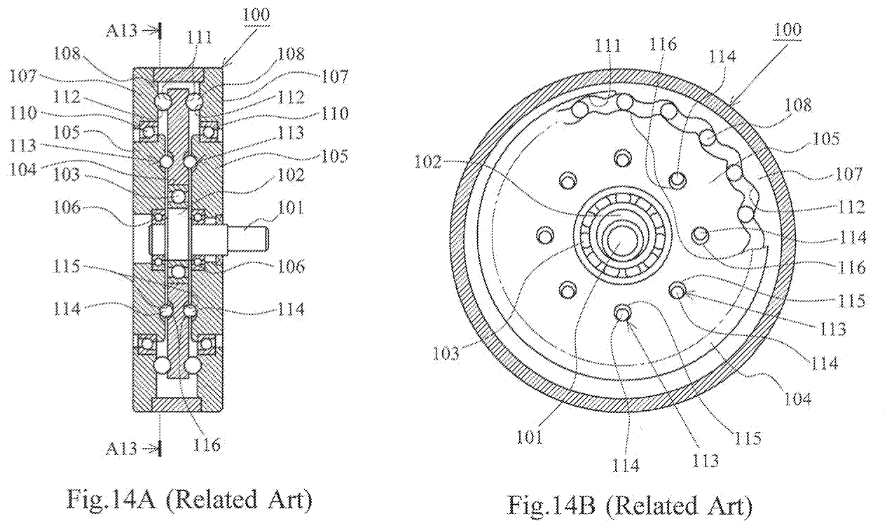

In the ball type speed reducer 1 according to this embodiment configured as described above, since the corrugated groove 31 is formed only in the second side face portion 40 of the output-side rotating body 7 facing the shaking body 4, it is possible to reduce the man-hours, compared to the ball type speed reducer 100 of the prior art (see FIG. 14) in which the corrugated grooves 111 and 112 are formed in four portions. In addition, in the ball type speed reducer 1 according to this embodiment, the shaking body 4 can be shaken independently from the fixing member 6 and the output-side rotating body 7. Therefore, it is not necessary to provide a complicated mechanism for rotating the shaking body 4 and the output-side rotating body 7 in synchronization (for example, the eccentricity absorption mechanism 113 of the ball type speed reducer 100 in the prior art). Accordingly, it is possible to simplify the structure and reduce the man-hours.

In the ball type speed reducer 1 according to this embodiment, the ball 5 is positioned in a portion where the radial groove 30 and the corrugated groove 31 intersect. Therefore, compared to the ball type speed reducer 100 of the prior art in which the balls 108 simultaneously come into contact with the groove wall of the first corrugated groove 111 of the eccentric rotating plate 104 and the groove wall of the second corrugated groove 112 of the fixing member 107 (see FIG. 14), it is possible to facilitate machining of the radial grooves 30 and the corrugated groove 31 and an assembly work for the shaking body 4, the fixing member 6, the output-side rotating body 7, and the like.

Since the ball type speed reducer 1 according to this embodiment has a gap between the flange portion 46 of the cover 8 and the second side face portion 40 of the output-side rotating body 7, it is possible to reduce a rotational resistance of the output-side rotating body 7 and improve power transmission efficiency. In addition, it is possible to prevent the second side face portion 40 of the output-side rotating body 7 from being deformed to be apart from the fixing member 6 using the flange portion 46 of the cover 8 by adjusting a gap amount between the flange portion 46 of the cover 8 and the second side face portion 40 of the output-side rotating body 7. Furthermore, it is possible to prevent ratcheting caused by the ball 5 inside the corrugated groove 31 moving from one groove of the neighboring wave to the other groove without moving along the corrugated groove 31. Note that the gap amount between the flange portion 46 of the cover 8 and the second side face portion 40 of the output-side rotating body 7 may be adjusted, for example, by nipping a gap adjustment shim (not shown) on an abutting surface between the cover installation portion 34 of the fixing member 6 and the flange portion 46 of the cover 8. In addition, the ratcheting may also occur between the neighboring radial grooves 30.

In the ball type speed reducer 1 according to this embodiment, the ball support protrusion 25 is formed in the first side face portion 24 of the fixing member 6 so as to protrude toward the shaking body 4 side, and a location where the ball 5 is held by the ball holding portion 23 of the shaking body 4 is placed closer to the second side face portion 40 of the output-side rotating body 7 relative to a center of the plate thickness direction of the shaking body 4 (relative to the center location between both the side faces 4a and 4b). As a result, in the ball type speed reducer 1 according to this embodiment, it is possible to deepen the groove depth of the corrugated groove 31 of the output-side rotating body 7 and reduce occurrence of ratcheting during power transmission.

In the ball type speed reducer 1 according to this embodiment, since a plurality of contact relief recesses 32, 33, 44, and 45 for reducing a contact resistance by reducing a contact area with the shaking body 4 are provided in the fixing member 6 and the output-side rotating body 7, it is possible to effectively transmit power. Note that, in the ball type speed reducer 1 according to this embodiment, since a viscous resistance of the grease applied between the fixing member 6 and the output-side rotating body 7 and the shaking body 4 can be reduced by filling grease inside the contact relief recesses 32, 33, 44, and 45 of the shaking body 4, it is possible to reduce an energy loss caused by the viscous resistance of the grease and effectively transmit power.

In the ball type speed reducer 1 according to this embodiment, since the balance weight 17 is fixed to the input shaft 2, and the rotation balance of the input shaft for shaking the shaking body 4 can be maintained using the eccentric disk cam 3, it is possible to prevent vibration or noise caused by imbalance of the rotation balance of the input shaft 2 and lengthen service lifetimes of the first to fourth bearings.

In the ball type speed reducer 1 according to this embodiment, if the number of waves of the corrugated groove 31 of the output-side rotating body 7 is set to “N”, the reduction ratio becomes “1/N”. Therefore, it is possible to increase the reduction ratio relative to the ball type speed reducer 100 of the prior art illustrated in FIG. 14.

### First Modification of First Embodiment

In the ball type speed reducer 1 according to this embodiment, the number “N” of waves of the corrugated groove 31 of the output-side rotating body 7 is set to “51”, the number “N+1” of the radial grooves 30 of the fixing member 6 is set to “52”, and the number of balls 5 is set to “52” by way of example. However, the present invention is not limited thereto. Alternatively, the number “N” of waves of the corrugated groove 31, the number “N+1” of the radial grooves 30, and the number of the balls 5 are determined depending on the obtained reduction ratio. Note that the number of the balls 5 may be smaller than the number of the radial grooves 30 as long as smooth rotation transmission of the ball type speed reducer 1 is not impaired.

### Second Modification of First Embodiment

In the ball type speed reducer 1 according to this embodiment, in a case where the output shaft rotating body 7 rotates in the same direction as that of the input shaft 2 without changing the reduction ratio, the number of waves of the corrugated groove 31 of the output-side rotating body 7 is set to “N”, the number of the radial grooves 30 of the fixing member 6 is set to “N−1”, and the number of the balls 5 is set to “N−1”. Furthermore, the radial grooves 30 are arranged at equal intervals in the circumferential direction of the fixing member 6. Note that the number of the balls 5 may be smaller than the number of the radial groove 30 as long as smooth rotation transmission of the ball type speed reducer 1 is not impaired.

### Third Modification of First Embodiment

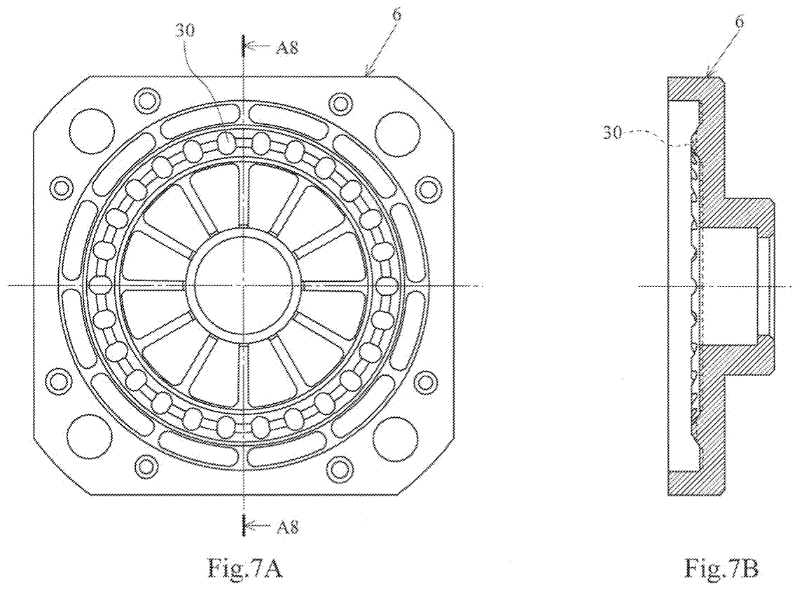

FIG. 7 is a diagram illustrating a third modification of the ball type speed reducer 1 according to this embodiment as a modification of the radial groove 30 of the fixing member 6. As illustrated in FIG. 7, if the number “N” of waves of the corrugated groove 31 of the output-side rotating body 7 is set to “51”, the number “in” of the radial grooves 30 of the fixing member 6 may be set to “(N+1)/2=26”. In addition, the number “in” of the balls 5 housed in the radial grooves 30 may be set to “(N+1)/2=26”. Note that the number of the balls 5 may be smaller than the number of the radial grooves 30 as long as smooth rotation transmission of the ball type speed reducer 1 is not impaired. Furthermore, this modification is established when the number “in” of grooves is a natural number, relative to the number “N” of waves of the corrugated groove 31 of the output-side rotating body 7. Moreover, if the number “N” of waves of the corrugated groove 31 of the output-side rotating body 7 is set to “51”, the number “in” of the radial grooves 30 of the fixing member 6 may be set to “(N−1)/2=25”. In addition, the number “m” of the balls 5 housed in the radial grooves 30 may be set to “(N−1)/2=25”.

In the ball type speed reducer 1 using the fixing member 6 according to this modification, the number of the balls 5 is reduced to a half, compared to the ball type speed reducer 1 of the first embodiment. Therefore, it is possible to reduce a total weight (achieve a light weight) and reduce a product cost. In addition, in the ball type speed reducer 1 using the fixing member 6 according to this modification, since the number of the balls 5 is reduced to a half, the size of the ball 5 can be set to be larger, and the groove depth of the corrugated groove 31 can be deepened. Therefore, it is possible to reduce occurrence of ratcheting during power transmission and increase a transmittable torque.

### Fourth Modification of First Embodiment

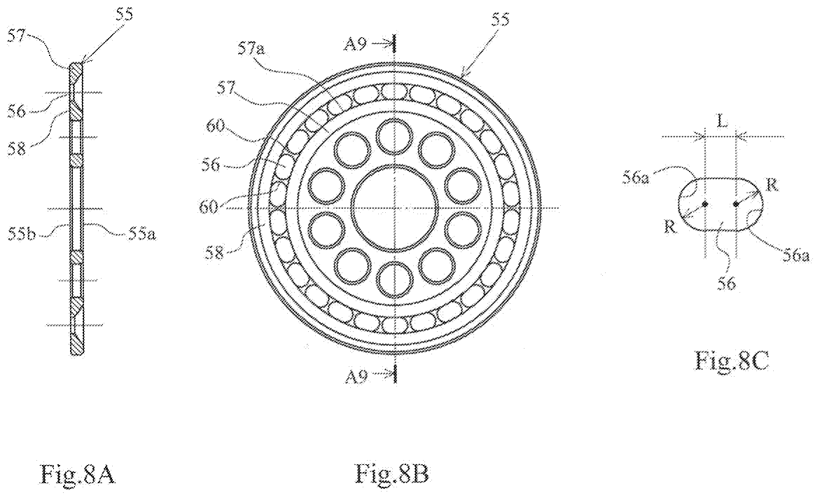

FIG. 8 is a diagram illustrating a modification of the shaking body 4 of the ball type speed reducer 1 of the first embodiment. Note that FIG. 8A is a longitudinal cross-sectional view illustrating the shaking body 55 according to this modification (cross-sectional view taken along the line A9-A9 of FIG. 8B to illustrate the shaking body 55). In addition, FIG. 8B is a front view illustrating the shaking body 55 according to this modification. Furthermore, FIG. 8C is an enlarged view illustrating the ball holding portion 56 of the shaking body 55.

The shaking body 55 according to this modification has the inner shake ring 21 and the outer shake ring 22 of the first embodiment connected in the radial direction using a plurality of ribs in an integrated manner. That is, the shaking body 55 according to this modification has an inner shake ring portion 57 having the same shape as that of the inner shake ring 21 of the first embodiment, an outer shake ring portion 58 having the same shape as that of the outer shake ring 22 of the first embodiment, a plurality of ribs 60 that integratedly connect the inner shake ring portion 57 and the outer shake ring portion 58, and ball holding portions 56 provided between the neighboring ribs 60. In addition, since the shaking body 55 has an outer circumference side of the inner shake ring portion 57 and an inner circumference side of the outer shake ring portion 58 connected using a plurality of ribs 60, the outer shake ring portion 58 is placed concentrically with the inner shake ring portion 57. A plurality of ribs 60 are provided at equal intervals along the outer circumferential surface 57a of the inner shake ring portion 57. The ball holding portion 56 is a long hole formed along the circumferential direction and has a semicircular portion 56a (having the same dimension as the radius R of the ball 5) of which both ends are adjacent to a generatrix of the ball 5. A gap “L” of a pair of semicircular portions 56a positioned to face each other is larger than a dimension “2e” twice the eccentric amount “e” of the eccentric disk cam 3. In a case where the shaking body 55 formed in this manner is used instead of the shaking body 4 of the first embodiment, one side face 55a of both side faces 55a and 55b is arranged to face the first side face portion 24 of the fixing member 6, and the other side face 55b of both side faces 55a and 55b is arranged to face the second side face portion 40 of the output-side rotating body 7. In addition, a movement (shaking) of the shaking body 55 is not restricted by the fixing member 6 and the output-side rotating body 7, and the shaking body 55 is appropriately shaken with respect to the fixing member 6 and the output-side rotating body 7, so as to function similar to the shaking body 4 of the first embodiment. Note that, in the shaking body 55 according to this modification, when the number “N” of waves of the corrugated groove 31 of the output-side rotating body 7 is set to “51”, twenty six long holes of the ball holding portion 56 are formed at equal intervals along the outer circumferential surface 57a of the inner shake ring portion 57, and each of the balls 5 is rollably housed in each ball holding portion 56 one by one.

In the ball type speed reducer 1 using the shaking body 55 according to this modification, it is possible to facilitate an assembly work, compared to the ball type speed reducer 1 of the first embodiment in which the inner shake ring 21 and the outer shake ring 22 are separate bodies. In addition, in the ball type speed reducer 1 using the shaking body 55 according to this modification, since twenty six balls 5 are used, it is possible to reduce a total weight (achieve a light weight) and a product cost, compared to the ball type speed reducer 1 of the first embodiment in which fifty two balls 5 are used.

### Fifth Modification of First Embodiment

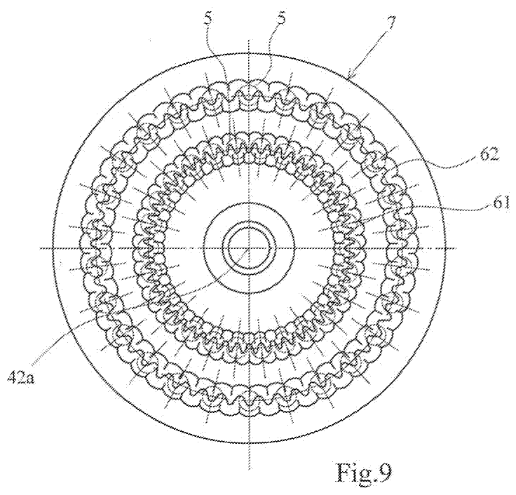

FIG. 9 is a diagram illustrating a modification of the corrugated groove 31 of the output-side rotating body 7. As illustrated in FIG. 9, the output-side rotating body 7 according to this modification has a first corrugated groove 61 formed in an annular shape around the rotation center 42a and a second annular corrugated groove 62 located concentrically with the first corrugated groove 61 and outward of the first corrugated groove 61 in the radial direction. The first and second corrugated grooves 61 and 62 are formed such that, when the number “N” of waves is set to “51”, the wave has an amplitude having the same dimension as the eccentric amount “e” of the eccentric disk cam 3. In addition, the balls 5 rolling inside the first corrugated groove 61 are housed in the radial grooves (not shown) of the fixing member 6 such that 26((N+1)/2) or 25((N−1)/2) balls 5 are arranged around the rotation center 42a of the output-side rotating body 7 (in the circumferential direction) at equal intervals. In addition, the balls 5 rolling inside the second corrugated groove 62 are housed in the radial grooves (not shown) of the fixing member 6 such that 26((N+1)/2) or 25((N−1)/2)) balls 5 are arranged around the rotation center 42a of the output-side rotating body 7 (in the circumferential direction) at equal intervals and are deviated by a half wave in the circumferential direction of the output-side rotating body 7 with respect to the balls 5 inside the first corrugated groove 61. Note that, in the ball type speed reducer 1 having the output-side rotating body 7 according to this modification, a shaking body (not shown) including an inner shake ring, a middle shake ring, and an outer shake ring or a shaking body (not shown) obtained by integrating and connecting the inner shake ring, the middle ring, and the outer shake ring using ribs in the radial direction is employed.

In the ball type speed reducer 1 having the output-side rotating body 7 according to this modification, it is possible to reduce an output torque variation (variation in the torque transmitted from the output-side rotating body 7 to the driven member), compared to the ball type speed reducer 1 of the third modification of the embodiment. Note that the size of the ball 5 rolling inside the first corrugated groove 61 may not be equal to the size of the ball rolling inside the second corrugated groove 62, and may be smaller than the size of the ball 5 rolling inside the second corrugated groove 62. In addition, the invention is not limited to a case where the ball 5 rolling inside the second corrugated groove 62 is deviated from the ball 5 inside the first corrugated groove 61 in the circumferential direction by a half wave. Instead, the ball 5 rolling inside the second corrugated groove 62 may be deviated from the ball 5 inside the first corrugated groove 61 in the circumferential direction by a deviation phase smaller than the half wave or larger than the half wave.

### Second Embodiment

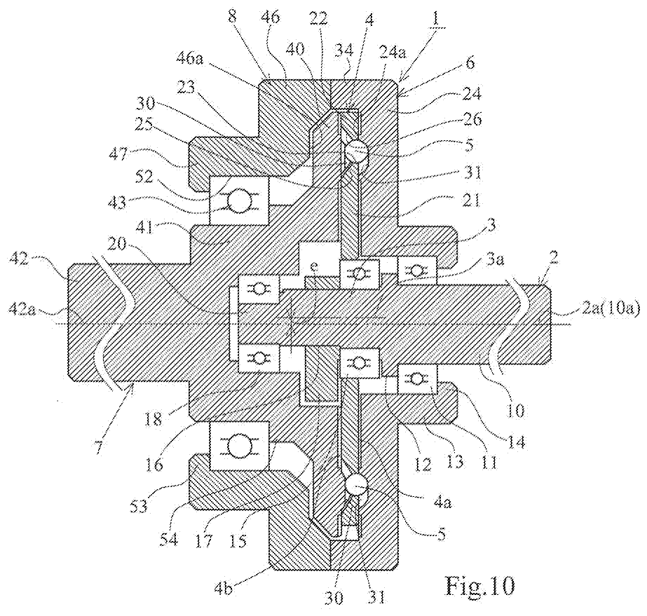

FIG. 10 is a longitudinal cross-sectional view illustrating a ball type speed reducer 1 according to a second embodiment of the invention. As illustrated in FIG. 10, similar to the ball type speed reducer 1 of the first embodiment, the ball type speed reducer 1 according to this embodiment includes an input shaft (input-side rotating body) 2, an eccentric disk cam 3, a shaking body 4, a plurality of balls 5, a fixing member 6, an output-side rotating body 7, a cover 8, and the like. The ball type speed reducer 1 according to this embodiment described above has a configuration similar to that of the ball type speed reducer 1 of the first embodiment, except that the corrugated groove 31 is formed in the fixing member 6, the radial grooves 30 are formed in the output-side rotating body 7, and the shaking body 4 is used in a front/back reversed manner. Therefore, in the description of the ball type speed reducer 1 according to this embodiment, like reference numerals denote like elements as in the ball type speed reducer 1 of the first embodiment, and they will not be repeatedly described.

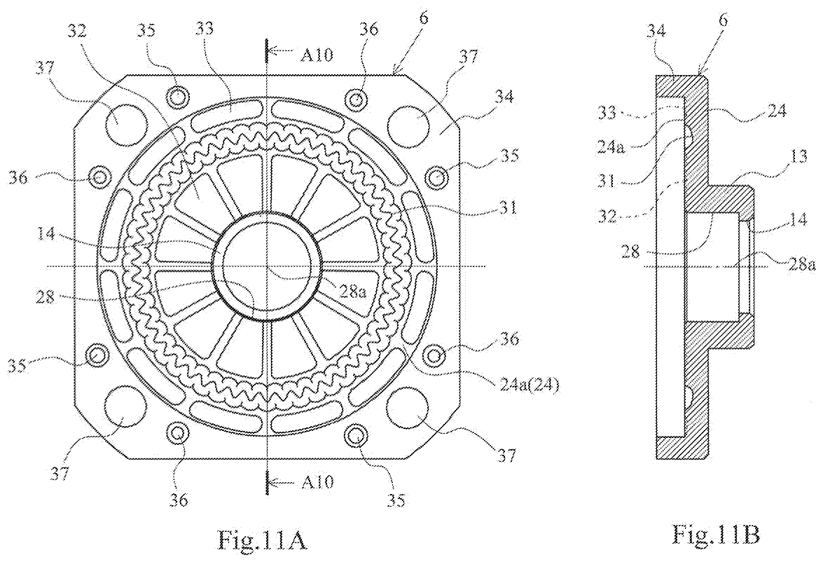

As illustrated in FIGS. 10 and 11, the annular corrugated groove 31 of the fixing member 6 is formed in the first side face portion 24 facing one side face 4a of both side faces 4a and 4b of the shaking body 4. The corrugated groove 31 has the same shape as that of the corrugated groove 31 formed in the second side face portion 40 of the output-side rotating body 7 of the ball type speed reducer 1 of the first embodiment, and the ball 5 housed in the ball holding portion 23 of the shaking body 4 is guided in the circumferential direction of the first side face portion 24 in an undulating manner.

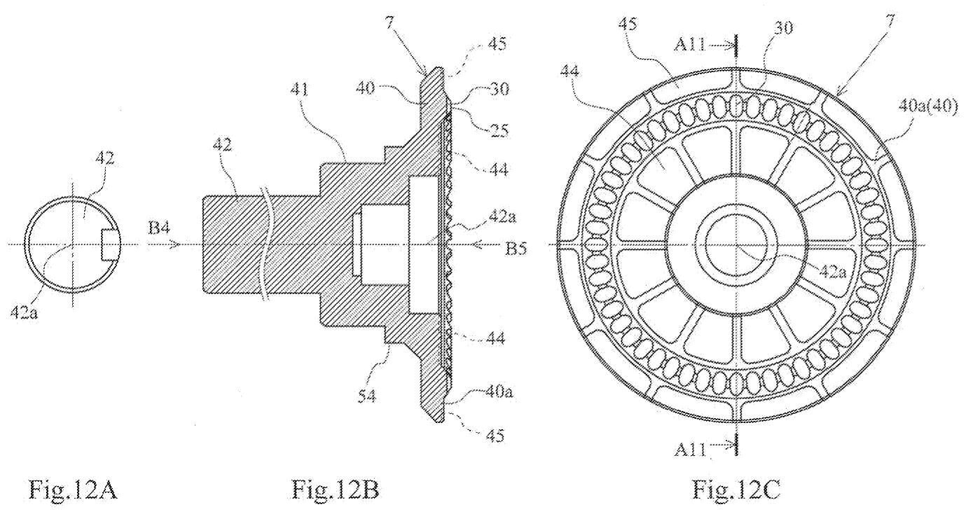

As illustrated in FIGS. 10 and 12, the output-side rotating body 7 has a plurality of radial grooves 30 formed in the second side face portion 40 facing the other side face 4b of both side faces 4a and 4b of the shaking body 4. The second side face portion 40 has a ball support protrusion 25 similar to the ball support protrusion 25 formed in the first side face portion 24 of the fixing member 6 of the ball type speed reducer 1 of the first embodiment. In addition, the ball support protrusion 25 has a plurality of radial grooves 30 formed circumferentially with equal intervals to be engaged with the balls 5 housed in the ball holding portion 23 of the shaking body 4. The radial groove 30 has a shape similar to that of the radial groove 30 formed in the first side face portion 24 of the fixing member 6 of the ball type speed reducer 1 of the first embodiment. In addition, similar to the number of the radial grooves 30 of the ball type speed reducer 1 of the first embodiment, the number of the radial grooves 30 in this case is set to “N+1” when the number of waves of the corrugated groove 31 is set to “N”.

In the ball type speed reducer 1 according to this embodiment described above, as the input shaft 2 and the eccentric disk cam 3 rotate by one turn in synchronization, the shaking body 4 is shaken by a dimension “2e” twice the eccentric amount “e” of the eccentric disk cam 3, and the balls 5 housed in the ball holding portion 23 of the shaking body 4 are moved inside the radial grooves 30 of the output-side rotating body 7 and inside the corrugated groove 31 of the fixing member 6. As a result, in the ball type speed reducer 1 according to this embodiment, when the number of waves of the corrugated groove 31 is set to “N”, the number of the radial grooves is set to “N+1”, and the number of the balls 5 is set to “N+1”, the output-side rotating body 7 rotates in the same direction as that of the input shaft 2 by “1/(N+1)” turn against one turn of the input shaft 2.

In the ball type speed reducer 1 according to this embodiment configured as described above, since the corrugated groove 31 is formed only in the first side face portion 24 of the fixing member 6 facing the shaking body 4, it is possible to reduce the man-hours, compared to the ball type speed reducer 100 of the prior art in which four corrugated grooves 111 and 112 are provided (see FIG. 14). In addition, similar to the ball type speed reducer 1 of the first embodiment, the ball type speed reducer 1 according to this embodiment is configured such that the shaking body 4 can be shaken independently from the output-side rotating body 7 and the fixing member 6. Therefore, it is not necessary to provide a complicated mechanism for rotating the shaking body 4 and the output-side rotating body 7 in synchronization (for example, the eccentricity absorption mechanisms 113 of the ball type speed reducer 100 of the prior art), and it is possible to simplify the structure and reduce the man-hours.

### First Modification of Second Embodiment

In the ball type speed reducer 1 according to this embodiment, the number “N” of waves of the corrugated groove 31 of the fixing member 6 is set to “51”, the number “N+1” of the radial grooves 30 of the output shaft rotating body 7 is set to “52”, and the number of the balls 5 is set to “52” by way of example. However, without limiting thereto, the number “N” of waves of the corrugated groove 31, the number “N+1” of the radial grooves 30, and the number of the balls 5 are determined depending on the obtained reduction ratio. Note that the number of the balls 5 may be smaller than the number of the radial grooves 30 as long as smooth rotation transmission of the ball type speed reducer 1 is not impaired.

### Second Modification of Second Embodiment

In the ball type speed reducer 1 according to this embodiment, when the number of waves of the corrugated groove 31 of the fixing member 6 is set to “N”, the number of the radial grooves 30 of the output shaft rotating body 7 is set to “N−1”, and the number of the balls 5 is set to “N−1”, as the input shaft rotates by one turn, the output-side rotating body 7 rotates oppositely to the input shaft 2 by “1/(N−1)” turn. Note that the number of the balls 5 may be smaller than the number of the radial grooves 30 as long as smooth rotation transmission of the ball type speed reducer 1 is not impaired.

### Third Modification of Second Embodiment

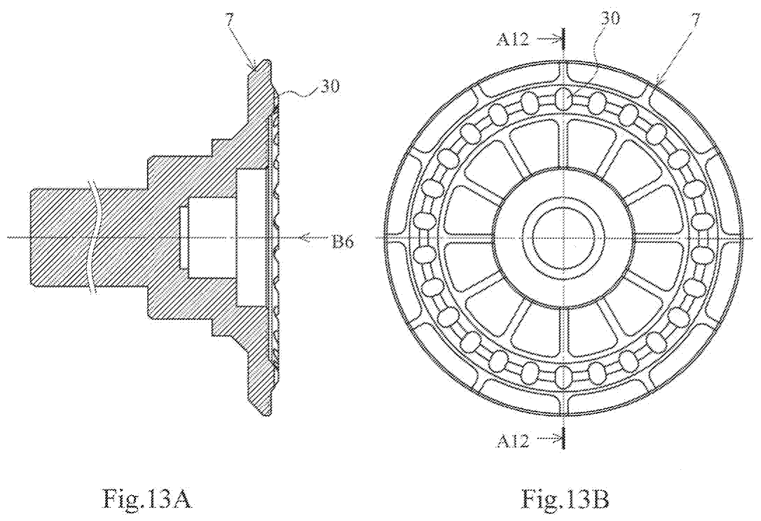

FIG. 13 is a diagram illustrating a ball type speed reducer 1 according to a third modification of this embodiment as a modification of the radial groove 30 of the output-side rotating body 7. As illustrated in FIG. 13, when the number “N” of waves of the corrugated groove 31 of the fixing member 6 is set to “51”, the number “in” of the radial grooves 30 of the output-side rotating body 7 may be set to “(N+1)/2=26”. In addition, the number “in” of the balls 5 housed in the radial grooves 31 may be set to “(N+1)/2=26”. Note that the number of the balls 5 may be smaller than the number of the radial grooves 30 as long as smooth rotation transmission of the ball type speed reducer 1 is not impaired. In addition, this modification is established when the number “in” of grooves is a natural number, relative to the number “N” of waves of the corrugated groove 31 of the fixing member 6. Furthermore, when the number “N” of waves of the corrugated groove 31 of the fixing member 6 is set to “51”, the number “m” of the radial grooves 30 of the output-side rotating body 7 may be set to “(N−1)/2=25”. In addition, the number “in” of the balls 5 housed in the radial grooves 30 may be set to “(N−1)/2=25”.

In the ball type speed reducer 1 having the output-side rotating body 7 according to this modification described above, the number of the balls 5 is reduced to a half, compared to the ball type speed reducer 1 of the second embodiment. Therefore, it is possible to reduce a total weight (achieve a light weight) and a product cost.

### Fourth Modification of Second Embodiment

Similar to the fourth modification of the first embodiment, the shaking body 4 of FIG. 3 may be used instead of the shaking body 55 of FIG. 8 in the ball type speed reducer 1 according to this embodiment. Therefore, it is possible to obtain the effects similar to those of the fourth modification of the first embodiment.

### Fifth Modification of Second Embodiment

Similar to the fifth modification of the first embodiment, in the ball type speed reducer 1 according to this embodiment, the corrugated groove 31 of the fixing member 6 of FIG. 11 may be substituted with the first and second corrugated grooves 61 and 62 of FIG. 9, and the twenty six (or twenty five) balls 5 located inside the first corrugated groove 61 at equal intervals may be housed in the radial grooves 30 formed in the output-side rotating body 7. In addition, twenty six (or twenty five) balls 5 located inside the second corrugated groove 62 at equal intervals may be housed in the radial grooves 30 formed in the output-side rotating body 7, and the balls 5 inside the radial grooves 30 may be rolled in the radial direction using the shaking body 4. In this modification, it is possible to obtain the effects similar to those of the fifth modification of the first embodiment.

### Modifications of First and Second Embodiments

In the ball type speed reducers 1 of the first and second embodiments, as illustrated in FIGS. 1 and 10, the ball bearings are employed as the first to fourth bearings 11, 15, 18, and 43 by way of example. Without limiting thereto, a roller bearing, a bushing, or the like may also be employed instead of the ball bearing.

In the ball type speed reducers 1 of the first and second embodiments, the entire assembly of the speed reducer (including the input shaft 2, the shaking body 4 or 55, the fixing member 6, the output-side rotating body 7, the cover 8, and the like) may be formed of metal, a part of the assembly may be formed of a synthetic resin material, or the entire assembly except for the first to fourth bearings 11, 15, 18, and 43 and the balls 5 may be formed of a synthetic resin material. In particular, in the ball type speed reducers 1 of the first and second embodiments, if the entire assembly except for the first to fourth bearings 11, 15, 18, and 43 and the balls 5 is formed of a synthetic resin material, it is possible to reduce the weight and lower the product cost. In addition, in the ball type speed reducers 1 of the first and second embodiments, if the entire assembly except for the first to fourth bearings 11, 15, 18, and 43 and the balls 5 is formed of a synthetic resin material, it is possible to reduce a contact sound of the ball (noise reduction) and suppress vibration. Furthermore, in the ball type speed reducers 1 of the first and second embodiments, if the shaking body 4 is formed of a synthetic resin material, the balls 5 are pressed to the inner shake ring 21 side by virtue of an elastic force of the outer shake ring 22, so that it is possible to suppress the balls 5 from running violently (rattling) inside the ball holding portion 23.

In the ball type speed reducers 1 of the first and second embodiments, if the number of waves of the corrugated groove 31 is set to “N”, the number of the radial grooves 30 and the number of the balls 5 may be set to “(N+1)/2” or “(N−1)/2”. Without limiting thereto, the number “in” of the radial grooves 30 and the number of the balls 5 may be set to “(N+1)/3” or “(N−1)/3”. In this case, the number “in” of the radial grooves 30 and the number of the balls 5 become natural numbers, the number “N+1” becomes a multiple of “3”, and the number “N−1” becomes a multiple of “3”.

In the ball type speed reducers 1 of the first and second embodiments, if the number “in” of the radial grooves 30 and the number of the balls 5 are reduced to be smaller than the number “N” of waves of the corrugated groove 31, the number “m” of the radial grooves 30 and the number of the balls 5 are preferably determined such that the radial grooves 30 and the balls 5 are placed in the circumferential direction at equal intervals. The ball type speed reducer 1 configured in this manner does not generate a torque variation caused by uneven arrangement of the radial grooves 30 and the balls 5 in the circumferential direction during power transmission, and enables smooth power transmission.

### REFERENCE SIGNS LIST

1 ball type speed reducer,
2 input shaft (input-side rotating body),
2a rotation center,
3 eccentric disk cam,
4, 55 shaking body,
4a, 4b, 55a, 55b side face,
5 ball,
6 fixing member,
7 output-side rotating body,
23, 56 ball holding portion,
24 first side face portion,
30 radial groove,
31, 61, 62 corrugated groove,
40 second side face portion,
42a rotation center (shaft center)

1. A ball type speed reducer that decelerates and transmits rotation of an input-side rotating body to an output-side rotating body, comprising:
an eccentric disk cam rotating in synchronization with the input-side rotating body;
a shaking body fitted relatively rotatably to an outer circumference side of the eccentric disk cam and shaken by the eccentric disk cam;
a plurality of balls housed in a ball holding portion of the shaking body; and
a fixing member having a first side face portion placed to face one of both side faces of the shaking body and fixed to a fixation target member,
wherein the ball holding portion of the shaking body is formed along a relative rotation direction between the shaking body and the eccentric disk cam to rollably house the plurality of balls along the relative rotation direction,
the output-side rotating body has a second side face portion positioned to face the other of the both side faces of the shaking body and has a shaft center as a rotation center positioned coaxially with the rotation center of the input-side rotating body,
when a direction extending radially from the rotation center is set as a radial direction on a virtual plane perpendicular to the rotation center of the input-side rotating body, any one of the first and second side face portions has a plurality of radial grooves formed around the rotation center of the input shaft side rotating body to rollably guide the balls along the radial direction of any one of the first and second side face portions,
when a direction extending along an outer edge of a virtual circle centered at the rotation center on the virtual plane is set as a circumferential direction, the other one of the first and second side face portions has an annular corrugated groove formed to guide the balls along the circumferential direction of the other one of the first and second side face portions in an undulating manner, and
the balls are rollably engaged inside the radial grooves and the corrugated groove and are rolled inside the radial grooves and the corrugated groove as the shaking body is shaken by the eccentric disk cam.

2. The ball type speed reducer according to claim 1, wherein a plurality of the radial grooves are formed in the first side face portion,
the corrugated groove is formed in the second side face portion, and
when the number of waves of the corrugated groove is set to “N”, and the number of the radial grooves is set to “N+1,” the output-side rotating body rotates oppositely to a rotation direction of the input-side rotating body by “1/N” of the rotation of the input-side rotating body.

3. The ball type speed reducer according to claim 1, wherein a plurality of the radial grooves are formed in the first side face portion,
the corrugated groove is formed in the second side face portion, and
when the number of waves of the corrugated groove is set to “N”, and the number of the radial grooves is set to “N−1,” the output-side rotating body rotates in the same direction as the rotation direction of the input-side rotating body by “1/N” of the rotation of the input-side rotating body.

4. The ball type speed reducer according to claim 1, wherein the corrugated groove is formed in the first side face portion,
a plurality of the radial grooves are formed in the second side face portion, and
when the number of waves of the corrugated groove is set to “N”, and the number of the radial grooves is set to “N+1,” the output-side rotating body rotates in the same direction as the rotation direction of the input-side rotating body by “1/(N+1)” of the rotation of the input-side rotating body.

5. The ball type speed reducer according to claim 1, wherein the corrugated groove is formed in the first side face portion,
the radial grooves are formed in the second side face portion, and
when the number of waves of the corrugated groove is set to “N”, and the number of the radial grooves is set to “N−1,” the output-side rotating body rotates oppositely to the rotation direction of the input-side rotating body by “1/(N−1)” of the rotation of the input-side rotating body.

6. The ball type speed reducer according to claim 1, wherein the shaking body includes an inner shake ring positioned in the outer circumference side of the eccentric disk cam and an outer shake ring disposed coaxially with the inner shake ring by interposing an annular gap in an outer side of a radial direction of the inner shake ring, and
the annular gap between the inner shake ring and the outer shake ring is the ball holding portion that rollably houses the balls.

7. The ball type speed reducer according to claim 1, wherein the shaking body includes an inner shake ring portion positioned in the outer circumference side of the eccentric disk cam, a plurality of ribs formed in an outer circumference of the inner shake ring portion at equal intervals, and an outer shake ring portion having an inner circumference side connected to tips of the ribs,
the inner shake ring portion and the outer shake ring portion are positioned coaxially, and
a ball holding portion that houses the balls and rolls the balls along the outer circumference of the inner shake ring portion is formed between the ribs.

8. The ball type speed reducer according to claim 1, wherein the corrugated groove includes a first corrugated groove placed inward in the radial direction and a second corrugated groove placed outward of the first corrugated groove in the radial direction,
when the numbers of waves of the first and second corrugated grooves are set to “N”, the number of the radial grooves intersecting the first corrugated groove is “(N+1)/2”, and the number of the radial grooves intersecting the second corrugated groove is “(N+1)/2”, and
the balls are positioned in a portion where the first corrugated groove and the radial grooves intersect and a portion where the second corrugated groove and the radial grooves intersect.

9. The ball type speed reducer according to claim 1, wherein the corrugated groove includes a first corrugated groove placed inward in the radial direction and a second corrugated groove placed outward of the first corrugated groove in the radial direction,
when the numbers of waves of the first and second corrugated grooves are set to “N”, the number of the radial grooves intersecting the first corrugated groove is “(N−1)/2”, and the number of the radial grooves intersecting the second corrugated groove is “(N−1)/2”, and
the balls are positioned in a portion where the first corrugated groove and the radial grooves intersect and a portion where the second corrugated groove and the radial grooves intersect.

10. The ball type speed reducer according to claim 8, wherein the radial grooves intersecting the first corrugated groove and the radial grooves intersecting the second corrugated groove are deviated by a half wave of the first corrugated groove.

11. The ball type speed reducer according to claim 9, wherein the radial grooves intersecting the first corrugated groove and the radial grooves intersecting the second corrugated groove are deviated by a half wave of the first corrugated groove.
